(19) United States
(12) Patent Application Publication
(10) Pub. No.: US 2009/0316407 A1
(43) Pub. Date: Dec. 24, 2009

(54) LIGHT EMITTING MODULE AND LIGHT EMITTING MODULE ARRAY

(75) Inventor: HOU-YAO LIN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/429,179

(22) Filed: Apr. 23, 2009

(30) Foreign Application Priority Data
Jun. 24, 2008 (CN) 200810302292.9

(51) Int. Cl. F21V 21/00; F21V 19/00

(52) U.S. Cl. 362/249.06; 362/382

(57) ABSTRACT

An exemplary light emitting module includes a main body, a first assembly portion and a second assembly portion. The main body includes a light source. The first assembly portion and a second assembly portion are arranged on two opposite sides of the main body. The first assembly portion includes a first assembly hole and a first assembly pole. The second assembly portion includes a second assembly hole and a second assembly pole.

### BACKGROUND

1. Technical Field

The present invention relates to light emitting modules, and particularly to light emitting modules using light emitting diodes and light emitting module array in large size.

2. Description of Related Art

As illumination devices, light emitting diodes (LEDs) have excellent characteristics, for example, small volume, good optical properties, low energy consumption, and long lifespan. LEDs are widely employed as light source for illumination.

However, light emitting diode modules normally have complex structures which is an inconvenient during assembly and installation of light emitting module array. Furthermore, the light emitting module array cannot be folded for easy storage when not in use because of the complex structures thereof.

Therefore, a new light emitting module and light emitting module array are desired to overcome the shortcomings described above.

### BRIEF DESCRIPTION OF THE DRAWINGS

Many aspects of the present light emitting module can be better understood with reference to the following drawings. The components in the drawings are not necessarily to scale, the emphasis instead being placed upon clearly illustrating the principles of the present light emitting module. Moreover, in the drawings, like reference numerals designate corresponding portions throughout the several views.

FIG. 1 is a schematic, isometric view of a light emitting module in accordance with an exemplary embodiment.

FIG. 2 is a schematic, isometric view on an opposite side of the light emitting module in FIG. 1.

FIG. 3 is a schematic, isometric view of a light emitting module array consisting of a plurality of light emitting modules in FIG. 1.

FIG. 4 is a schematic, isometric view in a folded state of the light emitting module array in FIG. 3.

### DETAILED DESCRIPTION

Reference will now be made to the drawings to describe in detail of the exemplary embodiments of the light emitting module.

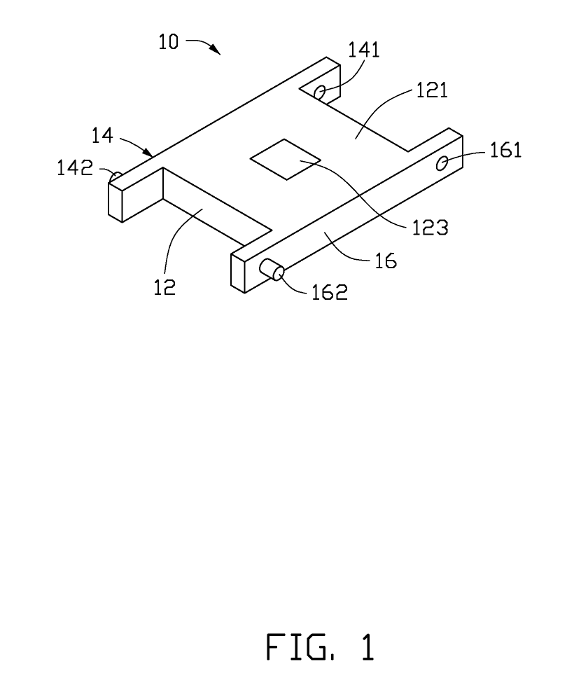

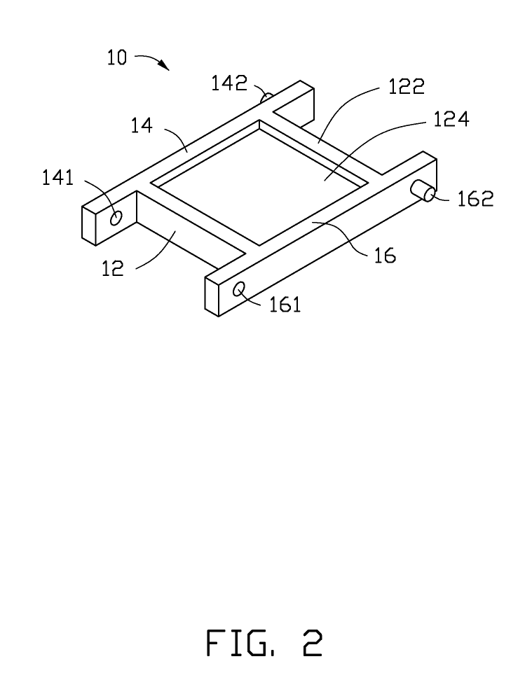

Referring to FIGS. 1 to 3, a light emitting module 10, in accordance with an exemplary embodiment, includes a main body 12, a first assembly portion 14 and a second assembly portion 16. The first and the second assembly portion 14, 16 are separately arranged at two opposite sides of the main body 12.

The main body 12 includes two opposite surfaces: the first surface 121 and the second surface 122. A light emitting element 123 is attached on the first surface 121. In the present embodiment, the light emitting element 123 is a light emitting diode (LED). It should be understood that the light emitting element 123 may be at least two LEDs or other kinds of light source. The main body 12 further includes a circuit board 124 which is electrically connected with the light emitting element 123. The circuit board 124 is attached on the second surface 122 of the main body 12. It should be understood that the circuit board 124 can also be arranged on the first surface 121 of the main body 12 under the light emitting element 123. The shape of the main body 12 may be rectangular, columnar, ellipsoidal or other shapes.

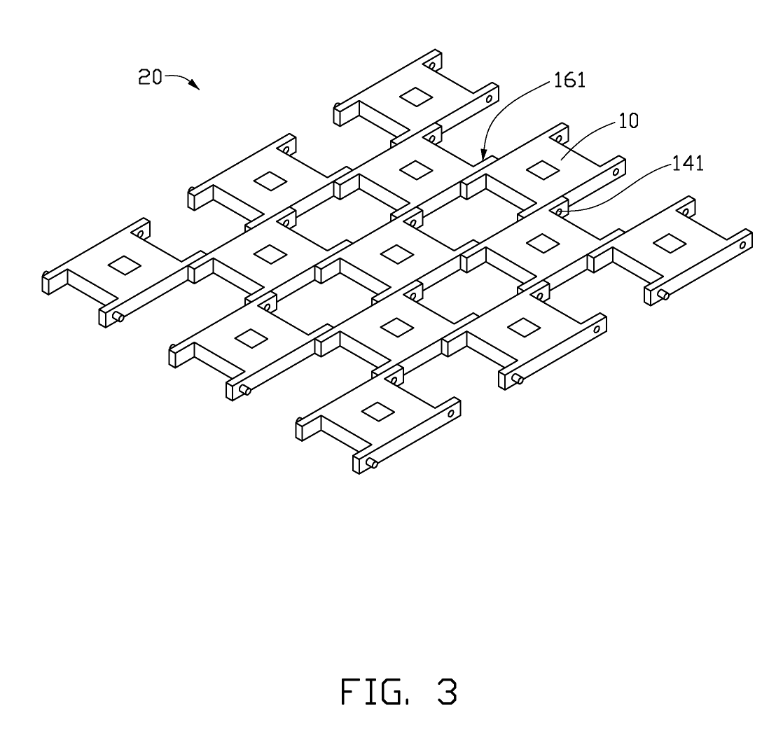

The first assembly portion 14 has the same shape with the second assembly portion 16. In the present embodiment, the first and the second assembly portions 14, 16 are rectangles. It should be understood that the first and the second assembly portions 14, 16 may be columnar or other shapes. The first assembly portion 14 includes a first assembly hole 141 and a first assembly pole 142 respectively arranged on two opposite ends of the first assembly portion 14. The second assembly portion 16 includes a second assembly hole 161 and a second assembly pole 162 respectively arranged on two opposite ends of the second assembly portion 16. The first assembly portion 14 is parallel with the second assembly portion 16. The diameter of the first assembly pole 142 is slightly smaller than the diameter of the second assembly hole 161. The diameter of the second assembly pole 162 is slightly smaller than the diameter of the first assembly hole 141. The first assembly pole 142 and the second assembly pole 162 are coaxial. A plurality of light emitting modules 10 can be coupled with each other to form a light emitting module array 20, as shown in FIG. 3. In detail, a second assembly pole 162 of a light emitting module 10 can be inserted into a first assembly hole 141 of an adjacent light emitting module, and a first assembly pole 142 of a light emitting module 10 can be inserted into a second assembly hole 161 of an adjacent light emitting module, such that a light emitting module array 20 is formed by the plurality of light emitting modules 10 combined with each other.

In the present embodiment, the light emitting module array 20 is an array of five rows and five columns. Thus, the number of the light emitting modules is thirteen. It should be understood that the numbers of the rows and the columns of the light emitting module array 20 can vary according to need.

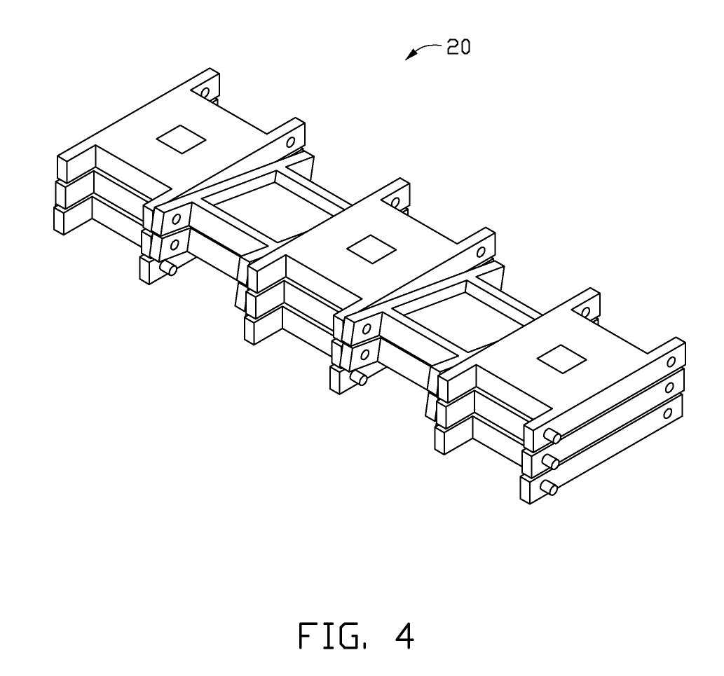

Furthermore, since the first and the second assembly poles 142, 162 are rotatable against the first and the second assembly holes 141, 161, when not in use, the light emitting module array 20 can be folded for convenient storage, as shown in FIG. 4. In detail, the light emitting modules of the same line are folded toward the same direction, and the light emitting modules of an adjacent line are folded toward an opposite direction. The way to fold the light emitting module array 20 is similar to folding a foldaway fan.

In the present embodiment, the first and the second assembly portions 14, 16 are integrally formed with the main body 12. It should be understood that the first and the second assembly portions 14, 16 may be juxtaposed with the main body 12, and they may be fixed to the main body 12 via adhesive or mechanical connection.

It should be understood that the shape of the first assembly portion 14 may be different from that of the second assembly portion 16. Such as, the first assembly portion 14 is a prism and the second assembly portion 16 is a column.

While the present invention has been described as having preferred or exemplary embodiments, the embodiments can be further modified within the spirit and scope of this disclosure. This application is therefore intended to cover any variations, uses, or adaptations of the embodiments using the general principles of the invention as claimed. Further, this application is intended to cover such departures from the present disclosure as come within known or customary practice in the art to which the invention pertains and which fall within the limits of the appended claims or equivalents thereof.

What is claimed is:

1. A light emitting module comprising:
a main body comprising a light source;
a first assembly portion and a second assembly portion arranged on two opposite sides of the main body, the first assembly portion comprising a first assembly hole and a first assembly pole, the second assembly portion comprising a second assembly hole and a second assembly pole.

2. The light emitting module of claim 1, wherein the first assembly pole and the second assembly pole are coaxial.

3. The light emitting module of claim 1, wherein the main body comprises a first surface and an opposite second surface, the light source being arranged on the first surface.

4. The light emitting module of claim 3, wherein the main body further comprises a circuit board arranged on the second surface, the light source and the circuit board are electrically connected.

5. The light emitting module of claim 3, wherein the main body further comprises a circuit board arranged on the first surface, and the light source and the circuit board are electrically connected.

6. The light emitting module of claim 1, wherein each of the first assembly portion and the second assembly portion is a cuboid or a cylinder.

7. The light emitting module of claim 1, wherein the first assembly portion and the second assembly portion are parallel with each other.

8. The light emitting module of claim 1, wherein the main body is a cuboid or a cylinder.

9. The light emitting module of claim 1, wherein the first and the second assembly portions are integrally formed with the main body.

10. The light emitting module of claim 1, wherein the first and the second assembly portions are juxtaposed with the main body, and are fixed to the main body.

11. The light emitting module of claim 1, wherein the light source comprises a light emitting diode.

12. A light emitting module array comprising:
a plurality of light emitting modules, each light emitting module comprising:
a main body comprising a light source;
a first assembly portion and a second assembly portion arranged on two opposite sides of the main body, the first assembly portion comprising a first assembly hole and a first assembly pole, the second assembly portion comprising a second assembly hole and a second assembly pole,
the first assembly hole of a light emitting module being coupled with the second assembly pole of a neighboring light emitting module, the first assembly pole of the light emitting module being coupled with the second assembly hole of another neighboring light emitting module, the plurality of light emitting modules thus connect with each other forming the light emitting module array.

13. The light emitting module array of claim 12, wherein the first assembly portion and the second assembly portion of each light emitting module are parallel with each other.

14. The light emitting module array of claim 12, wherein the first assembly pole and the second assembly pole are coaxial.

15. The light emitting module array of claim 12, wherein a diameter of the first assembly pole of a light emitting module is slightly smaller than a diameter of the second assembly hole of an neighboring light emitting module, and a diameter of the second assembly pole of the light emitting module is slightly smaller than a diameter of the first assembly hole of the neighboring light emitting module.

16. A light emitting module array comprising:
a first light emitting module, a second light emitting module and a third light emitting module, each light emitting module comprising:
a main body comprising a light source;
a first assembly portion and a second assembly portion arranged on two opposite sides of the main body, the first assembly portion comprising a first assembly hole and a first assembly pole, the second assembly portion comprising a second assembly hole and a second assembly pole,
the first assembly hole of the first light emitting module being coupled with the second assembly pole of the second light emitting module, the first assembly pole of the first light emitting module being coupled with the second assembly hole of the third light emitting module, the three light emitting modules thus connect with each other forming the light emitting module array.

17. The light emitting module array of claim 16, wherein the first assembly portion and the second assembly portion of each light emitting module are parallel with each other.

18. The light emitting module array of claim 16, wherein the first assembly pole and the second assembly pole are coaxial.

19. The light emitting module array of claim 16, wherein a diameter of the first assembly pole of the first light emitting module is slightly smaller than a diameter of the second assembly hole of the second light emitting module, and a diameter of the second assembly pole of the first light emitting module is slightly smaller than a diameter of the first assembly hole of the third light emitting module.
